(19) United States
(12) Patent Application Publication
(10) Pub. No.: US 2009/0191434 A1
(43) Pub. Date: Jul. 30, 2009

(54) FUEL CELL SYSTEM AND METHOD OF INFLUENCING THE HEAT AND TEMPERATURE BUDGET OF A FUEL CELL STACK

(75) Inventors: Stefan Käding, Zerrenthin (DE); Jeremy Lawrence, Dresden (DE); Norbert Günther, Damgarten (DE); Su Zhou, Shanghai (CN)

Correspondence Address: DICKINSON WRIGHT PLLC, 1875 Eye Street, NW, Suite 1200, WASHINGTON, DC, 20006, US

(73) Assignee: ENERDAY GMBH, Stockdorf (DE)

(21) Appl. No.: 12/439,640

(22) PCT Filed: Jul. 5, 2007
(86) PCT No.: PCT/DE2007/001187

§ 371 Date: Mar. 2, 2009

(30) Foreign Application Priority Data
Sep. 7, 2006 (DE) 10 2006 042 107.8

(51) Int. Cl. H01M 8/00; H01M 8/06; H01M 8/04

(52) U.S. Cl. 429/13; 429/26; 429/24

(57) ABSTRACT

The invention relates to a fuel cell system including a fuel cell stack (10), an afterburner (12) for combustion of exhaust gas emerging from the fuel cell stack and sited in an exhaust gas conduit of the afterburner a heat exchanger (16) in which cathode feed air (18) supplied to the fuel cell stack (10) can be heated.

In accordance with the invention it is provided for that cathode feed air (20) can be supplied to the fuel cell stack (10) without being prior heated in the heat exchanger (16) and that the heat and temperature balance of the fuel cell stack (10) can be tweaked by the overall flow of the cathode feed air supplied as well as by the ratio of the proportions (18, 20) of the cathode feed air as heated in the heat exchanger and as not heated in the heat exchanger.

The invention relates furthermore to a method of tweaking the heat and temperature balance of a fuel cell stack.

The invention relates to a fuel cell system including a fuel cell stack, an afterburner for combustion of exhaust gas emerging from the fuel cell stack and, sited in an exhaust gas conduit of the afterburner, a heat exchanger in which cathode feed air supplied to the fuel cell stack can be heated.

The invention relates furthermore to a method of influencing the heat and temperature budget—in other words, tweaking the heat and temperature balance—of a fuel cell stack sited in a fuel cell system, the fuel cell system furthermore comprising an afterburner for combustion of exhaust gas emerging from the fuel cell stack and, sited in an exhaust gas conduit of the afterburner, a heat exchanger in which cathode feed air supplied to the fuel cell stack can be heated.

As a unit central to a fuel cell system a fuel cell stack reacts a hydrogen rich reformate supply to the anode end of the fuel cell stack with a cathode feed air supply to the cathode end to produce electricity and heat. It is particularly in the case of solid oxide fuel cell (SOFC) systems that, because of the high temperatures involved, balancing the heat plays a major role. The heat and temperature balance of the fuel cell stack is tweaked by closed loop control of the supply of temperature-conditioned cathode feed air. For this purpose, before entering the fuel cell stack, the cathode feed air is passed through a heat exchanger to become heated. The heat needed for this purpose originates preferably in an afterburner which in employing air achieves exothermic oxidation of the depleted reformate tapped from the fuel cell stack. In this arrangement, the factor forming the basis of closed loop control is the temperature as sensed in the stream of cathode exhaust air leaving the fuel cell stack. Tweaking closed loop control is done by varying the cathode air flow rate, namely by setting the cathode air blower to a suitable rotary speed.

Circumstances may result in closed loop control on the basis of the cathode exhaust air temperature being inadequate due to the temperature distribution in the fuel cell stack not always having the wanted homogeneous profile. This can result in the fuel cell stack being cooled or heated to an unwanted extent which in turn stresses the fuel cell stack thermomechanically, causing drops in the output.

The invention is based on the object of making available a fuel cell system and a method of tweaking the heat and temperature balance of the fuel cell system which now achieves a homogeneous temperature distribution in the fuel cell stack.

This object is achieved by the features of the independent claims.

Advantageous embodiments of the invention read from the dependent claims.

The invention is a sophistication over the generic fuel cell system in that cathode feed air can be supplied to the fuel cell stack without being prior heated in the heat exchanger and that the heat and temperature balance of the fuel cell stack can be tweaked by the overall flow of the supplied cathode feed air as well as by the ratio of the proportion of the cathode feed air as heated in the heat exchanger and as not heated in the heat exchanger. In this way the heat and temperature balance of the fuel cell stack can now be tweaked with enhanced variability. The parameter available for tweaking is the overall flow of the supplied cathode feed air as well as the ratio of the individual cathode air proportions. This now makes it possible, for example, by increasing the proportion of cathode air passing through the heat exchanger relative to the non-heated cathode air proportion to increase the temperature of the air supply to the fuel cell stack whilst now being able to decide to what extent the overall flow of the cathode feed air should be. This now makes it possible to achieve an increase in temperature at the input of the fuel cell stack whilst still attaining the wanted drop in the cathode exhaust air temperature. In other words, the temperature can now be increased despite a drop in the heat input. Conversely, the temperature can now be maintained low at the input of the fuel cell stack despite more heat being entered because of the higher throughput of cathode feed air.

In accordance with a preferred embodiment of the present invention it is provided for that a first temperature sensor is provided for sensing the cathode feed air temperature before entering the fuel cell stack, that a second temperature sensor is provided for sensing the cathode exhaust air temperature after leaving the fuel cell stack, that a controller for mapping and processing the signals furnished by the temperature sensors and that the overall supply of cathode feed air as well as the ratio of the cathode feed air proportion heated in the heat exchanger and the proportion not heated in the heat exchanger can be tweaked as a function of the signals processed in the controller. Thus, tweaking the heat and temperature balance of the fuel cell stack is now possible on the basis of temperatures as mapped at the input and output of the fuel cell stack.

The invention is sophisticated as is particularly preferred in that a cathode air blower activated by the controller is provided, that the cathode air blower is followed by a flow divider likewise activated by the controller and that a first output flow of the flow divider forms the proportion of cathode feed air for supply to the fuel cell stack via the heat exchanger and a second output flow of the flow divider forms the proportion of cathode feed air supply to the fuel cell stack in bypassing the heat exchanger. Thus, by means of the rotary speed of the cathode air blower the flow of cathode feed air supplied overall can now be directly determined. Independently of this the temperature at the input of the fuel cell stack can now be set by setting the flow divider.

It is expediently provided for that before entering the fuel cell stack the proportions of cathode feed air can be mixed in a mixing zone and that the first temperature sensor is sited in or downstream of the mixing zone. The fuel cell stack can thus be engineered conventionally, i.e. with a sole feeder for the cathode feed air. Locating the temperature sensor in or downstream of the mixing zone now ensures that a temperature signal is made available which is independent of the setting of the flow divider.

In the scope of the present invention it is particularly of advantage that closed loop control of the temperature of the cathode feed air entering the fuel cell stack is provided on the basis of the signals furnished by the first temperature sensor by activating the flow divider and/or the cathode air blower. A closed control loop is thus achievable on the basis of the temperature sensed by the first temperature sensor at the input of the fuel cell stack. When the rotary speed of the cathode air blower is constant this control loop can be closed solely on the basis of the setting of the flow divider. However, even when the rotary speed of the cathode air blower is varied, the temperature at the input of the fuel cell stack can still be set to the required level by tweaking the flow divider. It is just as conceivable, however, that when the temperature is changed as wanted at the input of the fuel cell stack, to leave the setting of the flow divider constant and to change the rotary speed of the cathode air blower. And even if there is no change in the ratio of the cathode air proportions there will nevertheless be a change in temperature at the input of the fuel cell stack, as a rule, because the heat flow transfer in the heat exchanger and the air flowing through the heat exchanger will not be linearly proportional.

It may furthermore be provided for that closed loop control of the temperature of the fuel cell stack is on the basis of the signals furnished by the second temperature sensor in activating the flow divider and/or the cathode air blower. When the air throughput through the fuel cell stack is known, the difference between the cathode feed air temperature and the anode exhaust air temperature is a measure of the temperature of the fuel cell stack, and thus when the two temperatures are known, varying the temperature in the fuel cell stack is achievable by tweaking the rotary speed of the cathode air blower and/or tweaking the flow divider. When the flow divider is linked to a closed control loop working on the basis of the cathode feed air temperature and providing closed loop control of the cathode exhaust air temperature to a setpoint value, closed loop control of the sp temperature of the cathode exhaust air is possible solely on the basis of the cathode exhaust air temperature by tweaking the cathode air blower, resulting ultimately in the temperature of the fuel cell stack being set.

The invention is a sophistication over the generic method in that the fuel cell stack is supplied with a cathode feed air proportion with, and a cathode feed air proportion without being previously heated in the heat exchanger and that the heat and temperature balance of the fuel cell stack is tweaked by the overall flow of cathode feed air supplied and by the ratio of the cathode feed air proportions. It is in this way that the advantages and special features of the fuel cell system in accordance with the invention are also achieved in the scope of a method, this applying likewise to the preferred embodiments of the method in accordance with the invention as discussed in the following.

This is expediently sophisticated in that the cathode feed air temperature before entering the fuel cell stack is sensed by a first temperature sensor, that the cathode exhaust air temperature after leaving the fuel cell stack is sensed by a second temperature sensor, that the signals furnished by the temperature sensors are mapped and processed by a controller and, that the overall supply of cathode feed air as well as the ratio of the cathode feed air proportions are tweaked as a function of the signals processed in the controller.

It may be furthermore provided for that a cathode air blower is activated by the controller, that the cathode air blower followed by a flow divider is activated by the controller, and that a first output flow of the flow divider forms the proportion of cathode feed air for supply to the fuel cell stack via the heat exchanger and a second output flow of the flow divider forms the proportion of cathode feed air supply to the fuel cell stack in bypassing the heat exchanger.

It is likewise provided for to advantage that before entering the fuel cell stack the proportions of cathode feed air are mixed, and that the first temperature sensor senses the temperature of the mixture as generated.

The invention is sophisticated particularly expediently in that closed loop control of the temperature of the cathode feed air entering the fuel cell stack is now provided on the basis of the signals furnished by the first temperature sensor by activating the flow divider and/or the cathode air blower.

It may be furthermore provided for that that closed loop control of the temperature of the fuel cell stack is on the basis of the signals furnished by the second temperature sensor by activating the flow divider and/or the cathode air blower.

The invention is based on having discovered that tweaking the heat and temperature balance of the fuel cell stack is made available with enhanced variability due to setting the overall flow of cathode feed air and setting the temperature of the cathode feed air now being independent of each other. It may prove particularly expedient to achieve setting the overall flow of cathode feed air and the cathode air proportions in the scope of closed control loops working on the basis of the cathode feed air temperature and the cathode exhaust air temperature respectively.

The invention will now be detailed by way of a particularly preferred embodiment with reference to the attached drawings in which:

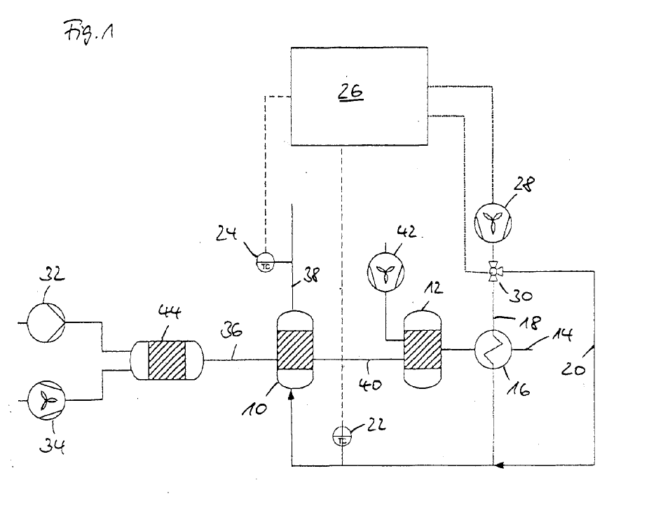

FIG. 1 is a diagrammatic representation of a fuel cell system in accordance with the invention.

Referring now to FIG. 1 there is illustrated a diagrammatic representation of a fuel cell system in accordance with the invention. The fuel cell system comprises a reformer 44 receiving a supply of fuel and air via a fuel feeder 32 and a blower 34 respectively. In addition to the fuel feeder and blower 34 respectively as shown further fuel feeders and blowers may be provided, enabling the reforming process to be varied in design. In the present example the reformer 30 is used to perform a catalytic reforming which works solely on the basis of air as the oxidant. It is understood, however, that the present invention is not restricted to this, it being likewise possible that other oxidants are used, for example, water. In the reformer 44 a hydrogen rich reformate 36 is generated which is supplied to the anode end of a fuel cell stack 10. The cathode end of the fuel cell stack 10 receives a supply of cathode feed air via a cathode air blower 28. At the output end cathode exhaust air 38 and anode exhaust gas 40 leave the fuel cell stack 10. The depleted reformate leaving the fuel cell stack as anode exhaust gas 40 is forwarded to an afterburner 12 into which further air is introduced as oxidant by an afterburner air blower 42. The afterburner 12 may be likewise assigned a further fuel feeder. In the afterburner 12 an oxidation reaction occurs so that ultimately the exhaust gas leaving the afterburner 12 is totally oxidized, the exhaust gas 14 passes through a heat exchanger 16. Sited upstream of the heat exchanger 16 in the direction of flow of the cathode feed air delivered by the cathode air blower 28 is a reformer 30. This flow divider generates a cathode air proportion 18 which passes through the heat exchanger 16 and a cathode air proportion 20 bypassing the heat exchanger 16. Before the cathode feed air enters the fuel cell stack 10 the cathode air proportions 18, 20 are mixed. Two temperature sensors 22, 24 are provided, a first temperature sensor 22 sensing the temperature of the cathode feed air, i.e. the temperature of the intermixed cathode air proportions 18, 20. A further temperature sensor 24 senses the temperature of the cathode exhaust air 38. The signals furnished by the temperature sensors 22, 24 are forwarded to a controller 26 which tweaks the rotary speed of the cathode air blower 28 in setting the reformer 30. The controller may handle other tasks, for example, total control of the fuel cell system.

The assembly as presently described achieves two closed control loops, one of which is based on the cathode feed air temperature sensed by the temperature sensors 22, whereby the setting of the flow divider serves as the manipulated variable, whilst a further closed control loop may work on the basis of the cathode exhaust air temperature sensed by the temperature sensor 24. In this case, the rotary speed of the cathode air blower 28 is used as the manipulated variable. It is likewise just as possible to operate the closed control loop using the rotary speed of the cathode air blower 28 on the basis of the difference in temperature between the temperature sensors 22, 24 for the cathode feed air and cathode exhaust air. But in any case, as compared to conventional prior art systems in which closed loop control of the cathode air flow is normally on the basis of the temperature of the cathode exhaust air, additional possibilities are now made available for tweaking the operation of the fuel cell system, particularly as regards the heat and temperature balance of the fuel cell stack 10.

It is understood that the features of the invention as disclosed in the above description, in the drawings and as claimed may be essential to achieving the invention both by themselves or in any combination.

### LIST OF REFERENCE NUMERALS

10 fuel cell system
12 afterburner
14 exhaust gas conduit/exhaust gas
16 heat exchanger
18 cathode feed air proportion
20 second cathode air proportion
22 temperature sensor
24 temperature sensor
26 controller
28 cathode air blower
30 flow divider
32 fuel feeder
34 blower
36 reformate
38 cathode exhaust air
40 anode exhaust air
42 afterburner air blower
44 reformer

1. A fuel cell system including a fuel cell stack, an afterburner for com-bustion of exhaust gas emerging from the fuel cell stack and sited in an exhaust gas conduit of the afterburner a heat exchanger in which cathode feed air for sup-ply to the fuel cell stack can be heated, comprising:
cathode feed air can be supplied to the fuel cell stack without being prior heated in the heat exchanger and
that the heat and temperature balance of the fuel cell stack can be tweaked by the overall flow of the supplied cathode feed air as well as by the ratio of the proportion of the cathode feed air as heated in the heat exchanger and as not heated in the heat exchanger.

2. The fuel cell system of claim 1, further comprising
a first temperature sensor for sensing the cathode feed air temperature before entering the fuel cell stack,
a second temperature sensor for sensing the cathode exhaust air temperature after leaving the fuel cell stack,
a controller for mapping and processing the signals furnished by the temperature sensors, and
that the overall supply of cathode feed air as well as the ratio of the cathode feed air proportion heated in the heat exchanger and the proportion not heated in the heat exchanger can be tweaked as a function of the signals processed in the controller.

3. The fuel cell system of claim 2, further comprising:
a cathode air blower activated by the controller,
the cathode air blower is followed by a flow divider activated by the controller, and
that a first output flow of the flow divider forms the proportion of cathode feed air for supply to the fuel cell stack via the heat exchanger and a second output flow of the flow divider forms the proportion of cathode feed air supply to the fuel cell stack in bypassing the heat exchanger.

4. The fuel cell system of claim 1, wherein
before entering the fuel cell stack the proportions of cathode feed air are mixed in a mixing zone, and
that the first temperature sensor is sited in or downstream of the mixing zone.

5. The fuel cell system of claim 3, wherein closed loop control of the temperature of the cathode feed air entering the fuel cell stack is provided on the basis of the signals furnished by the first temperature sensor by activating the flow divider and/or the cathode air blower.

6. The fuel cell system of claim 3, wherein closed loop control of the temperature of the fuel cell stack is provided on the basis of the signals furnished by the second temperature sensor in activating the flow divider and/or the cathode air blower.

7. A method of tweaking the heat and temperature balance of a fuel cell stack sited in a fuel cell system, the fuel cell system furthermore comprising an afterburner for combustion of exhaust gas emerging from the fuel cell stack and sited in an exhaust gas conduit of the afterburner a heat exchanger in which cathode feed air supplied to the fuel cell stack can be heated, comprising the steps of:
supplying the cell stack with a cathode feed air proportion with, and a cathode feed air proportion without being previously heated in the heat ex-changer, and
tweaking the heat and temperature balance of the fuel cell stack is tweaked by the overall flow of cathode feed air supplied and by the ratio of the cathode feed air proportions.

8. The method of claim 7, further comprising the steps of:
sensing the cathode feed air temperature before entering the fuel cell stack is sensed by a first temperature sensor,
sensing the cathode exhaust air temperature after leaving the fuel cell stack by a second temperature sensor 2,
mapping and processing the signals furnished by the temperature sensors by a controller and,
tweaking the overall supply of cathode feed air as well as the ratio of the cathode feed air proportions as a function of the signals processed in the controller.

9. The method of claim 8, wherein
a cathode air blower is activated by the controller,
the cathode air blower followed by a flow divider is activated by the controller, and
that a first output flow of the flow divider forms the proportion of cathode feed air for supply to the fuel cell stack via the heat exchanger and a second output flow of the flow divider forms the proportion of cathode feed air supply to the fuel cell stack in bypassing the heat exchanger.

10. The method of claim 9, wherein
before entering the fuel cell stack the proportions of cathode feed air are mixed, and
that the first temperature sensor senses the temperature of the mixture as generated.

11. The method of claim 9, wherein the temperature of the cathode feed air entering the fuel cell stack is controlled in a closed loop on the basis of the signals furnished by the first temperature sensor by activating the flow divider and/or the cathode air blower.

12. The method of claim 9, wherein the temperature of the fuel cell stack is controlled in a closed loop on the basis of the signals furnished by the second temperature sensor by activating the flow divider and/or the cathode air blower.
